(19) United States
(12) Patent Application Publication
(10) Pub. No.: US 2010/0102663 A1
(43) Pub. Date: Apr. 29, 2010

(54) ELECTRICAL MACHINE

(76) Inventors: Alexandra Wilde, Sindelfingen (DE); Arndt Kelleter, Gerlingen (DE); Kurt Reutlinger, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/520,296

(22) PCT Filed: Nov. 13, 2007
(86) PCT No.: PCT/EP07/62244

§ 371 Date: Dec. 16, 2009

(30) Foreign Application Priority Data
Dec. 19, 2006 (DE) 10-2006-059-933.0
Jun. 20, 2007 (DE) 10-2007028-347.6

(51) Int. Cl. H02K 21/14

(52) U.S. Cl. 310/156.38

(57) ABSTRACT

The present invention relates to an electrical machine having a rotor, a stator, a rotating-field production device, and a pole-field production device. The rotor can rotate about a rotation axis which passes through opposed upper and lower portions of the rotor. The rotating-field production produces an essentially radial magnetic field which rotates about the rotation axis of the rotor. The pole-field production device produces a magnetic field of opposite polarity to the rotor on the upper and lower portions. In order to reduce the size of the electrical machine without reducing the power, the pole-field production device has at least one magnet.

### PRIOR ART

The present invention relates to an electrical machine as generically defined by the preamble to claim 1 and to a pump as defined by claim 13.

An electrical machine of this kind, also known as a synchronous homopolar or equipolar machine, includes a rotor, a stator, a rotary field generator and a pole field generator; the rotor is rotatable about an axis of rotation, which passes through two opposed portions of the rotor, and the rotary field generator is arranged for generating an essentially radial magnetic field, which rotates about the axis of rotation of the rotor, and the pole field generator is arranged for generating a magnetic field which polarizes the rotor oppositely at the opposed portions. The pole field generator is embodied as a coil which is integrated with the stator.

Such electrical machines can also rotate faster than machines that have a commutator, and thus they can be used for example for actuating a pump which pumps a smaller volume per pumping cycle than a different pump and therefore can also be embodied smaller than the other pump that has the same pumping capacity, since it can be operated at a higher frequency. Such electrical machines are therefore taken into consideration as a compressor drive for fuel cells, so as to save on both installation space and weight.

One disadvantage is that although the electrical machine makes the space-saving embodiment of a pump possible, the electrical machine itself occupies a great deal of space.

The present invention furthermore relates to a pump having an electrical machine according to the invention.

### DISCLOSURE OF THE INVENTION

The object of the present invention is to make an electrical machine, and a pump for which the machine is used, smaller without sacrificing capacity.

The object of the invention is attained by means of an electrical machine having the characteristics of the body of claim 1 and by a pump for an electrical machine having the characteristics of claim 13.

According to the invention, the pole field generator includes at least one magnet.

Advantageously, energy is saved, since no current is required for generating the magnetic field that polarizes the rotor oppositely at the opposed portions.

In a preferred embodiment, the stator includes two stator elements, which are disposed along the axis of rotation, and the at least one magnet is disposed between the two stator elements.

Advantageously, the space that must be present between two stator elements can be utilized to accommodate the magnet. Heat can easily be dissipated from the magnet to the two stator elements of the stator. Moreover, the magnet is protected against contrary fields by the two stator elements, so that demagnetization can be averted.

In a refinement of the preferred embodiment, a housing is provided that is not magnetic.

Advantageously, a magnetic short circuit through the housing can be avoided.

In still another preferred embodiment, the stator includes two stator elements. which are disposed along the axis of rotation; the at least one magnet is embodied as a hollow cylinder, which surrounds one of the stator elements; and a further magnet embodied as a hollow cylinder surrounds the other of the two stator elements.

Advantageously, heat can easily be dissipated from the magnets to the stator elements. Moreover, the magnets are protected against contrary fields by the stator elements, so that demagnetization can be averted. Because of the large area of contact between the stator elements and the magnets, economical ferrite magnets can generate an adequate magnetic field.

In a refinement of the preferred embodiment, a housing is provided which is magnetic.

Advantageously, the magnetic resistance can be reduced by providing that the magnetic field lines extend almost entirely through a magnetic material.

In still another preferred embodiment, the stator includes two stator elements, which are disposed along the axis of rotation; the at least one magnet is embodied in blocklike form and is disposed on the outside of the two stator elements; and a further magnet is provided, which is embodied in blocklike form and is disposed on the outside of the other of the two stator elements.

Advantageously, heat can easily be dissipated from the magnets to the stator elements. Moreover, the magnets are protected against contrary fields by the stator elements, so that demagnetization can be averted. A block-shaped form can furthermore be produced easily and therefore economically. Tolerances between stator elements and the magnets are furthermore of hardly any significance.

In a refinement of the preferred embodiment, the pole field generator includes still further blocklike magnets, which are disposed on the outside of the stator elements.

Advantageously, a magnetic field that is symmetrical to the axis of rotation can be generated by means of a plurality of blocklike magnets.

In still another refinement of the preferred embodiment, a housing is provided which is magnetic.

In still another preferred embodiment, the stator includes two stator elements, which are disposed along the axis of rotation; the at least one magnet is embodied in blocklike form and is disposed on the outside of the two stator elements; and a further magnet is provided, which is embodied in blocklike form and is disposed on the outside of the other of the two stator elements.

In a refinement of the preferred embodiments, each stator element comprises a plurality of annular parts.

Advantageously, the dimensions of the stator elements can be reduced so far, yet with high efficiency of the machine, that they can be produced with adequate quality by pressing soft magnetic material.

In still another preferred embodiment, the stator comprises a soft magnetic composite material.

Advantageously, eddy current losses in the stator can be reduced. Such a stator furthermore has virtually identical magnetic properties in all directions. Compared to laminated stators, the magnetic resistance in the axial direction transversely to the laminations is furthermore markedly less, which leads to an improvement in efficiency.

In still another preferred embodiment, the electrical machine includes a further rotor, a further stator, a further rotary field generator, and a further pole field generator, the further rotor being rotatable about the axis of rotation, which passes through two further opposed portions of the further rotor, and the further pole field generator is arranged for generating a further magnetic field which polarizes the further rotor oppositely on the further opposed portions, and the further pole field generator includes at least one magnet.

Advantageously, the dimensions of the stator elements can be reduced so far, yet with high efficiency of the machine, that they can be produced with adequate quality by pressing soft magnetic material.

The electrical machine can be as both an electric motor and a generator for outputting electrical energy.

### BRIEF DESCRIPTION OF THE DRAWINGS

The invention is described in further detail below in conjunction with the drawings.

These show:

FIG. 1A, a view of an electrical machine having one magnet between two stator elements of a stator;

FIG. 1B, a sectional view of the electrical machine of FIG. 1A viewed along its axis of rotation;

FIG. 1C, a further view of the electrical machine of FIG. 1A and the field line course of the magnetic field generated by a pole field generator;

FIG. 2A, a view of an electrical machine with hollow-cylindrical magnets that surround the stator;

FIG. 2B, a sectional view of the electrical machine of FIG. 2A along its axis of rotation;

FIG. 3A, a view of an electrical machine with a plurality of magnets that surround the stator;

FIG. 3B, a sectional view of the electrical machine of FIG. 3A along its axis of rotation;

FIG. 4, a sectional view of an electrical double machine along its axis of rotation; and

FIG. 5, a sectional view of an electrical machine in which each stator element comprises a plurality of parts.

### EMBODIMENTS OF THE INVENTION

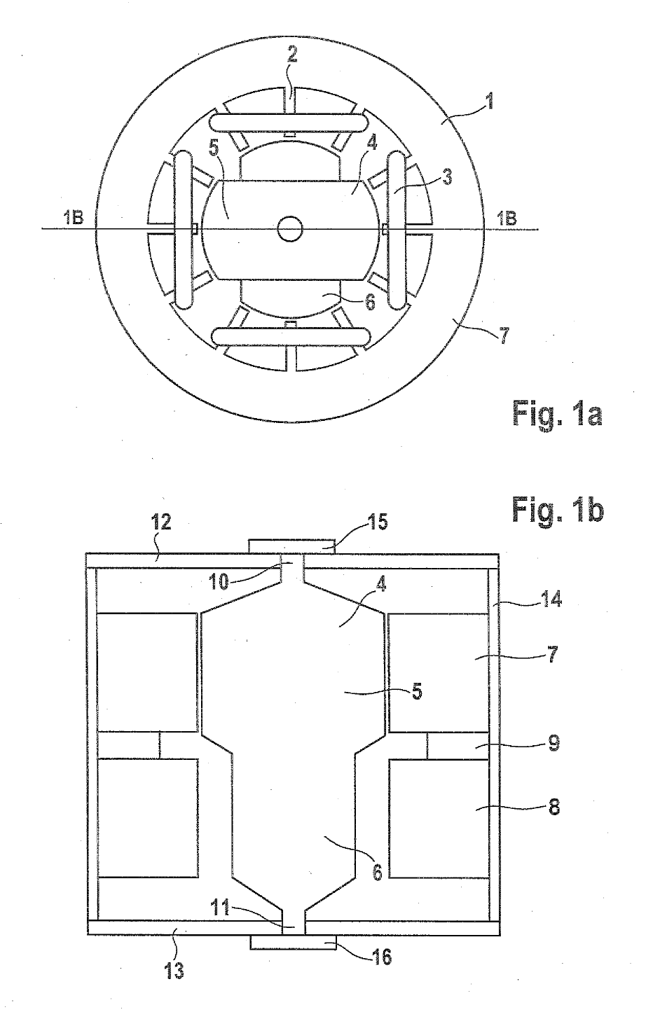

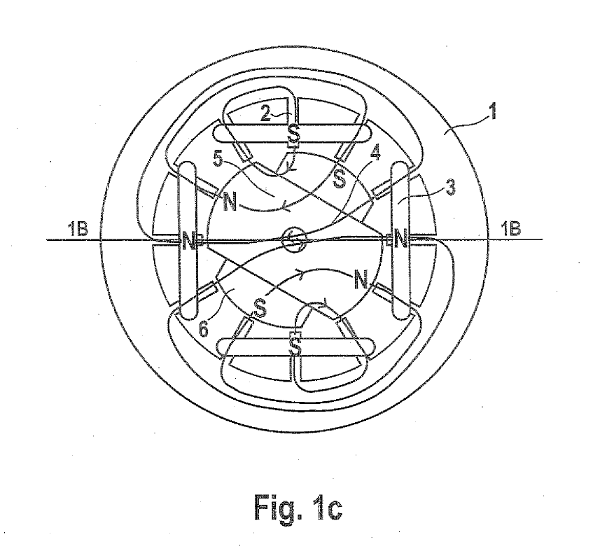

FIG. 1A shows a view of an electrical machine having one magnet between two structurally identical stator elements of a stator 1, perpendicular to the axis of rotation of a rotor 4. The two stator elements are disposed along the axis of rotation one above the other. In this view, the upper 7 of the two stator elements hides the other of the two stator elements and the magnet, which acts as a pole field generator. The housing is not shown. For this and the further embodiments, the stator elements comprise a soft magnetic material, preferably a soft magnetic composite material (soft magnetic composite or SMC), such as compressed oxidized iron powder, in order to suppress eddy currents. The stator elements may be pressed directly into the mold or can be shaped by spark erosion after the pressing. The stator elements have a hollow-cylindrical shape, and protrusions 2 project radially inward on their inner circumferences 12. One coil 3 is wound about each three protrusions 2, disposed one above the other, of the two stator elements (in other words, a total of six protrusions). For the sake of simplicity, a total of four coils are shown, which serve to generate a magnetic field which rotates about the axis of rotation of the rotor 4. Conventionally, there are twelve coils, each wound around three protrusions offset by one of the twelve protrusions, so that each protrusion is surrounded by three coils. The rotor 4 likewise comprises a soft magnetic material, is supported rotatably in the interior of the stator 1, and along its axis of rotation includes one upper portion 5 and one lower portion 6. Each portion 5, 6 includes two opposed round outer faces, which are each located close to the inward-projecting protrusions 2 of the upper stator element 7 and of the lower stator element, so that there is only a narrow gap between these protrusions 2 and the opposed portions 5, 6. Between the two opposed round outer faces of each portion 5, 6, there are two respective opposed flat parallel outer faces. The opposed outer faces of the portion 6 are rotated by 90° relative to the opposed outer faces of the portion 5. Instead of the four-pole machine described here, a machine with an arbitrary other number of poles and protrusions can be used, as known from the prior art.

FIG. 1B shows a sectional view of the electrical machine of FIG. 1A along its axis of rotation. The corresponding section line is shown as line 1B-1B in FIG. 1A. The coils 3 are not shown. Between the two cylindrical stator elements 7, 8 of the stator 1, there is an annular magnet 9, which generates a magnetic field which polarizes the rotor 4 oppositely at the upper portion 5 and the lower portion 6. The magnet 9 may be composed of a plurality of partial magnets, such as magnet shells in the form of half rings. Protrusions that are embodied between the protrusions 2 of the two stator elements may also be embodied on the magnet 9. On the opposite ends of the rotor 4, an upper journal 10 and a lower journal 11 are embodied in one piece with the rotor 4. The journals 10, 11 are supported in an upper and lower housing cap 12, 13, respectively, which caps are secured to the opposed ends of a cylindrical housing 14. The housing 14 is not magnetic, so as to prevent a magnetic short circuit through the housing 14. Upper and lower end caps 15, 16, which cover a bearing, are seated in the middle of the upper and lower housing caps 12, 13, respectively. One or both journals 10, 11 may also change over into a shaft (not shown) that is provided outside the housing 14 in order to transmit the torque of the machine to a pump in a known manner. The pump is used for instance in a turbine of a compressor drive for a fuel cell. The upper portion 5 is shown along its large cross section from one rounded outer face to the opposed rounded outer face, while the lower portion 6 is shown along its small cross section from a flat outer face to the opposed outer face. Along a line that is rotated by 90° about the axis of rotation relative to the line 1B-1B, the result is a cross section for the rotor 4 for which the upper portion 5 is embodied like the lower portion 6 in FIG. 1B and for which the lower portion 5 is embodied like the upper portion 6 in FIG. 1B.

FIG. 1C shows a further view of the electrical machine of FIG. 1A and the field line course of the magnetic field generated by the magnet 9. The rotor 4, however, is shown in a rotated position compared to the position in FIG. 1A. Only the components of the magnetic field perpendicular to the axis of rotation of the rotor 4 are shown. The magnetic field lines enter the lower portion 5 of the rotor 4 via the inward-projecting protrusions 2 of the stator 1, so that two opposed magnet poles S are embodied on the lower portion 6 of the rotor 4. The magnetic field lines enter the inward-projecting protrusions 2 of the stator 1 again via two opposed ends of the upper portion 5 so that at the upper end of the rotor 4, two opposed magnet poles N are embodied. The magnetic flux extends almost exclusively through the protrusions 2, which border closely on the stator 4. Because of the construction of the rotor 4, the magnet poles S on the lower portion 6 of the rotor 4 are offset by 90° from the magnet poles N on the upper portion 5 of the rotor 4. By application of a current of a suitable direction, magnet poles N and S can be embodied in alternation on the inward-pointing sides of the coils 2, and these poles are disposed such that they attract and repel the magnet poles N, S, respectively, of the rotor in the clockwise direction. If the rotor 4 has rotated far enough clockwise that a magnet pole S of the rotor 4 is located precisely diametrically opposite an inward-pointing magnet pole N of a coil 3, and a magnet pole N of the rotor 4 is located precisely diametrically opposite an inward-pointing magnet pole S of a coil 3, the current direction in the coils 3 is changed. As a result, the magnet poles of the rotor 4 are further respectively repelled and attracted, so that the rotor 4 continues rotating clockwise.

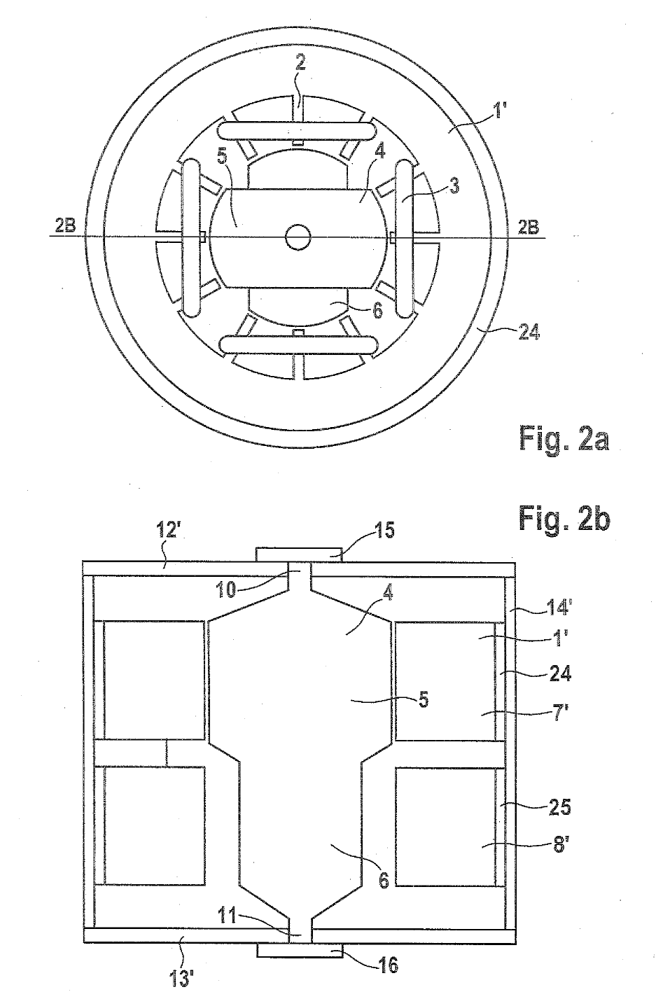

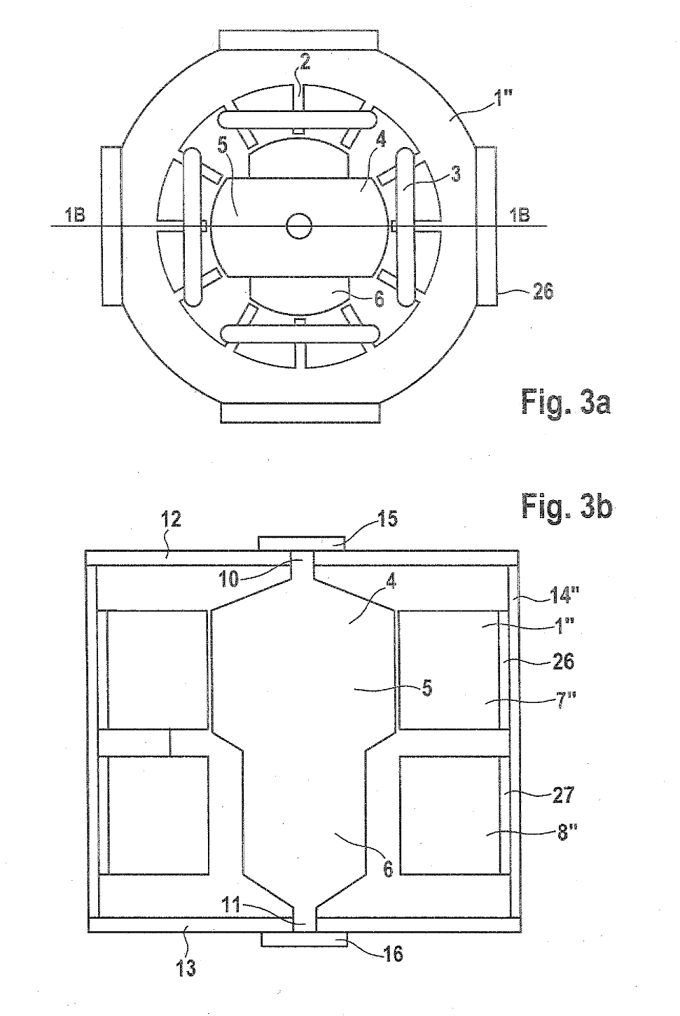

The following electrical machines in FIGS. 2A, 2B and FIGS. 3A, 3B differ from the electrical machine of FIGS. 1A and 1B in terms of the magnet or magnets which generate the magnetic field for polarizing the rotor. For identical elements, identical reference numerals will be used hereinafter, and for modified elements, identical reference numerals provided with one, two or three primes will be used.

FIG. 2A shows a view of an electrical machine with hollow-cylindrical magnets 24, 25 (hidden) that generate the magnetic field for polarizing the rotor 4. The magnets 24, 25 may also be composed of a plurality of partial magnets, such as two half rings. FIG. 2B shows a sectional view of the electrical machine of FIG. 2A along its axis of rotation. The corresponding section line is shown in FIG. 2A as the line 2B-2 . The coils 3 are not shown. The stator 1′ comprises two annular stator elements 7′, 8′, which are each surrounded by the respective magnet 24 and 25. The magnets 24, 25 are polarized radially and oppositely. Between the two annular stator elements 7′, 8′, an air gap is embodied, in order to avoid a magnetic short circuit between the stator elements 7′, 8′. The housing 14′ comprises a magnetic material, in order to reduce the magnetic resistance by forming a magnetic bridge through the housing 14′. It is possible to use only one of the magnets 24, 25 and to dispense with the other magnet.

FIG. 3A shows a view of an electrical machine with a plurality of magnets 26, 27 (hidden) that generate the magnetic field for polarizing the rotor 4. The magnets 26, 27 are embodied in blocklike form. The places on the stator elements of the stator 1″, which are otherwise round on the outside, where the magnets 26, 27 rest on the stator elements of the stator 1″ are flattened, to enable good contact between the stator 1″ and the magnets 26, 27. The number of magnets 26, 27 is arbitrary. However, the magnets 26, 27 should be disposed symmetrically, so as to generate a correspondingly symmetrical magnetic field. FIG. 3B shows a sectional view of the electrical machine of FIG. 3A along its axis of rotation. The stator 1″ comprises two annular stator elements 7″, 8″, which are each surrounded by a plurality of magnets 26 and 27, respectively. The magnets 26, 27 are polarized radially. The magnets 26 are polarized oppositely to the magnets 27. Between the two annular stator elements 7″, 8″, an air gap is embodied, to avoid a magnetic short circuit between the stator elements 7″, 8″. The housing 14″ comprises a magnetic material, in order to reduce the magnetic resistance by forming a magnetic bridge through the housing 14″. It is possible to use only one of the magnets 26, 27 and to dispense with the other magnet.

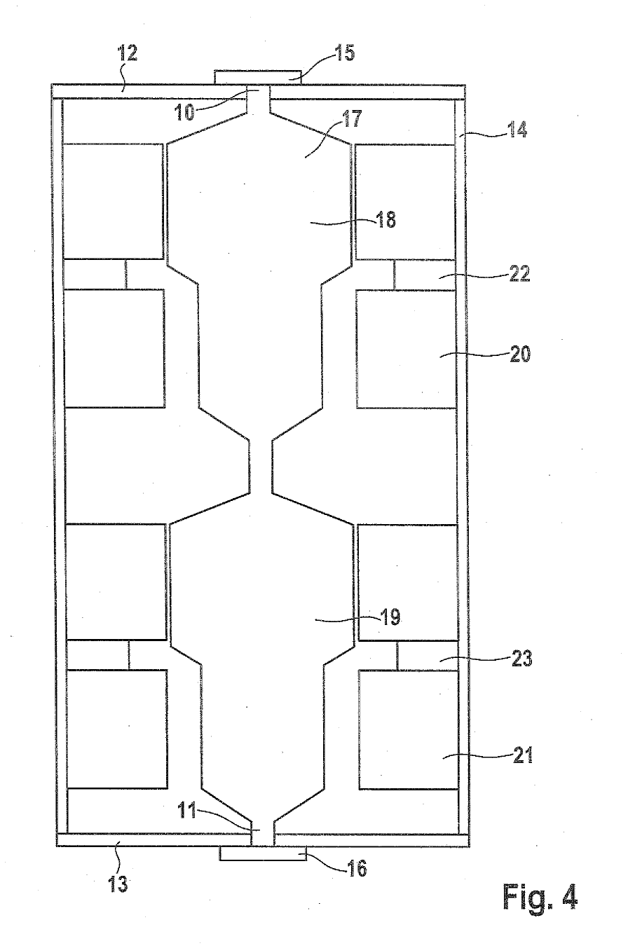

FIG. 4 shows a sectional view of an electrical double machine along its axis of rotation. The double rotor 17 comprises two rotors 18 and 19, which are embodied in one piece and each have the same construction as the rotor 4 in the preceding drawings. The two rotors 18, 19 are joined to one another in such a way that the joined-together portions are oriented identically, and one stator element 20 can be used in order to polarize the two joined-together portions. The stator includes two further stator elements 21, which are separated from the stator element 20 by respective magnets 22 and 23. Alternatively, stators and magnets as known from FIGS. 2A, 2B and 3A, 3B may be used, and two adjoining stator elements are embodied in one piece as in FIG. 4.

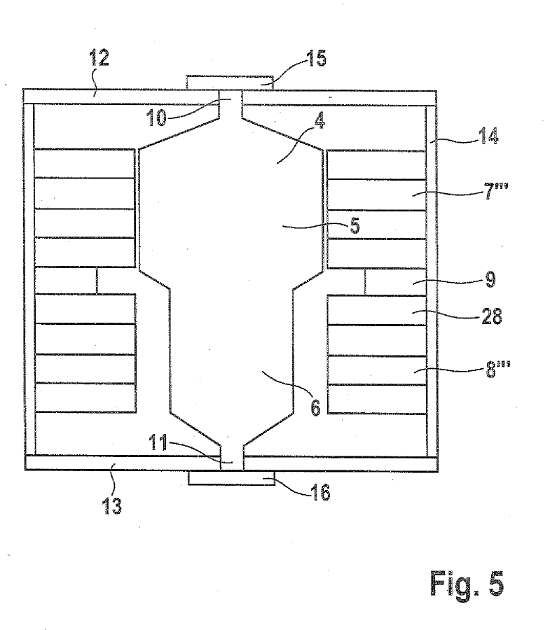

FIG. 5 shows a sectional view through an electrical machine in which each stator element 8′″ comprises a plurality of annular parts 28.

The electrical machines shown in FIGS. 1 through 5 may be used both as a motor and as a generator for generating electrical energy.

1-13. (canceled)

14. An electrical machine, comprising:
a rotor being rotatable about an axis of rotation, which passes through two opposed portions of the rotor;
a stator;
a rotary field generator arranged to generate an essentially radial magnetic field that rotates about the axis of rotation of the rotor; and
a pole field generator arranged to generate a magnetic field that polarizes the rotor oppositely at the opposed portions, wherein the pole field generator includes at least one magnet.

15. The electrical machine as defined by claim 14, wherein the stator includes two stator elements which are disposed along the axis of rotation, and the at least one magnet is disposed between the two stator elements.

16. The electrical machine as defined by claim 15, wherein a housing is provided that is not magnetic.

17. The electrical machine as defined by claim 14, wherein the stator includes two stator elements which are disposed along the axis of rotation, the at least one magnet is embodied as a hollow cylinder which surrounds one of the two stator elements, and a further magnet embodied as a hollow cylinder surrounds an other of the two stator elements.

18. The electrical machine as defined by claim 17, wherein a housing is provided, which is magnetic.

19. The electrical machine as defined by claim 14, wherein the stator includes two stator elements which are disposed along the axis of rotation, the at least one magnet is embodied in blocklike form and is disposed on an outside of one of the two stator elements, and a further magnet is provided which is embodied in blocklike form and is disposed on the outside of an other of the two stator elements.

20. The electrical machine as defined by claim 19, wherein the pole field generator includes still further blocklike magnets, which are provided on the outside of the two stator elements.

21. The electrical machine as defined by claim 19, wherein a housing is provided, which is magnetic.

22. The electrical machine as defined by claim 20, wherein a housing is provided, which is magnetic.

23. The electrical machine as defined by claim 15, wherein each stator element comprises a plurality of annular parts.

24. The electrical machine as defined by claim 17, wherein each stator element comprises a plurality of annular parts,

25. The electrical machine as defined by claim 19, wherein each stator element comprises a plurality of annular parts.

26. The electrical machine as defined by claim 14, wherein the stator comprises a soft magnetic composite material.

27. The electrical machine as defined by claim 23, wherein the stator comprises a soft magnetic composite material.

28. The electrical machine as defined by claim 14, further comprising a further rotor, a further stator, a further rotary field generator, and a further pole field generator, the further rotor being rotatable about the axis of rotation, which passes through two further opposed portions of the further rotor, and the further pole field generator is arranged for generating a further magnetic field which polarizes the further rotor oppositely on the further opposed portions, and the further pole field generator includes at least one magnet.

29. The electrical machine as defined by claim 26, further comprising a further rotor, a further stator, a further rotary field generator, and a further pole field generator, the further rotor being rotatable about the axis of rotation, which passes through two further opposed portions of the further rotor, and the further pole field generator is arranged for generating a further magnetic field which polarizes the further rotor oppositely on the further opposed portions, and the further pole field generator includes at least one magnet.

30. The electrical machine as defined by claim 14, wherein the electrical machine is an electric motor or an electric generator.

31. The electrical machine as defined by claim 28, wherein the electrical machine is an electric motor or an electric generator.

32. A pump having an electrical machine, operated as an electric motor, as defined by claim 14.

33. A pump having an electrical machine, operated as an electric motor, as defined by claim 28.
